(19) United States
(12) Patent Application Publication
(10) Pub. No.: US 2015/0158590 A1
(43) Pub. Date: Jun. 11, 2015

(54) AIRCRAFT OCCUPANT RESTRAINT PRETENSIONING DEVICES, SYSTEMS AND METHODS

(71) Applicant: AmSafe, Inc., Phoenix, AZ (US)

(72) Inventors: William J. Gehret, Chandler, AZ (US); Giuseppe Gullotto, Mesa, AZ (US); Robert Scott, Phoenix, AZ (US)

(21) Appl. No.: 14/565,207

(22) Filed: Dec. 9, 2014

Related U.S. Application Data
(60) Provisional application No. 61/913,872, filed on Dec. 9, 2013.

(51) Int. Cl. B64D 11/06

(52) U.S. Cl. CPC B64D 11/062

(57) ABSTRACT

Occupant restraint systems for use with aircraft occupant restraint systems and other restraint systems, and associated devices and methods are disclosed herein. In one embodiment, an occupant restraint system can include a flexible web configured to extend across at least a portion of a lap of an occupant positioned on a seat of an aircraft, and an electronically-actuated pretensioner operably coupled to an end portion of the web. The system can also include a sensor assembly operably coupled to the pretensioner, wherein the sensor assembly is configured to send an electrical signal to the pretensioner in response to an aircraft acceleration or deceleration above a preset magnitude, and wherein, in response to receiving the electrical signal from the sensor assembly, the pretensioner is configured to automatically increase tension on the web.

### CROSS-REFERENCE TO RELATED APPLICATION(S)

This application claims the benefit of U.S. Provisional Patent Application No. 61/913,872, filed Dec. 9, 2013, which is incorporated by reference herein in its entirety.

### TECHNICAL FIELD

The following disclosure relates generally to aircraft occupant restraint systems, and more particularly to aircraft occupant restraint systems having pretensioning devices and associated systems and methods.

### BACKGROUND

Commercial aircraft seats typically include two-point restraint systems to secure occupants. Unlike three- and four-point restraints, conventional two-point restraints may not restrict forward movement of the occupant's head toward a forward structure. Several conventional two-point restraints seek to address this problem, such as by use of webbing with low-elongation properties. However, low-elongation webbing only limits head excursion a small amount and can cause high contact loading over a short time period (e.g., immediate deceleration of the occupant against the webbing). Another conventional restraint system that seeks to limit head excursion is a “Y-belt restraint.” A Y-belt restraint utilizes an additional attachment element that raises the height of the seatbelt on the occupant's torso and consequently raises the rotation point of the occupant about the seatbelt. Y-belt restraints, however, may also have disadvantages. First, the additional attachment element requires additional attachment points on the seat structure and additional reinforcement elements to support the additional attachment points. This additional structure increases seat weight and complexity. Second, Y-belt restraints are generally uncomfortable for the occupant. Third, the Y-belt restraint can position the belt at a location that is up and away from the pelvic region of the occupant. During a dynamic event (e.g., a rapid deceleration and/or acceleration, collisions, impacts, etc.) the occupant's body is loaded and point-restrained at the belt contact area which is misaligned with the protective skeletal structure of the pelvic region.

### BRIEF DESCRIPTION OF THE DRAWINGS

FIG. 1A is a partially schematic front perspective view of an occupant restraint system configured in accordance with an embodiment of the present technology, and FIG. 1B is a partially schematic side view of the occupant restraint system of FIG. 1A.

FIGS. 2A and 2B are side and top views, respectively, illustrating a reduction in head path excursion during a dynamic event with an occupant restraint system configured in accordance with the present technology.

FIG. 3A is a partially-schematic side view of a pretensioner suitable for use with an occupant restraint system configured in accordance with an embodiment of the present technology, and FIG. 3B is a partially schematic cross-sectional side view of the pretensioner of FIG. 3A.

FIG. 4 is an isolated side view of another pretensioner suitable for use with an occupant restraint system configured in accordance with an embodiment of the present technology.

FIG. 5 is a front view of an occupant restraint system configured in accordance with another embodiment of the present technology.

### DETAILED DESCRIPTION

The present disclosure describes various embodiments of aircraft occupant restraint systems having pretensioning systems. Although embodiments of the present technology are described herein in the context of airplane occupant restraint systems (e.g., commercial airline occupant restraint systems), those of ordinary skill in the art will understand that the various apparatuses, systems and methods described herein can also be used in other types of vehicles, such as other types of aircraft (e.g., helicopters, etc.). Accordingly, aspects and embodiments of the present disclosure are not limited to use in airplanes. In the following description, numerous specific details are discussed to provide a thorough and enabling description for embodiments of the technology. One skilled in the relevant art, however, will recognize that the disclosure can be practiced without one or more of the specific details. In other instances, well-known structures or operations often associated with occupant restraint systems are not shown, or are not described in detail, to avoid obscuring aspects of the technology. In general, alternatives and alternate embodiments described herein are substantially similar to the previously described embodiments, and common elements are identified by the same reference numbers.

### I. Selected Embodiments of Occupant Restraint Systems

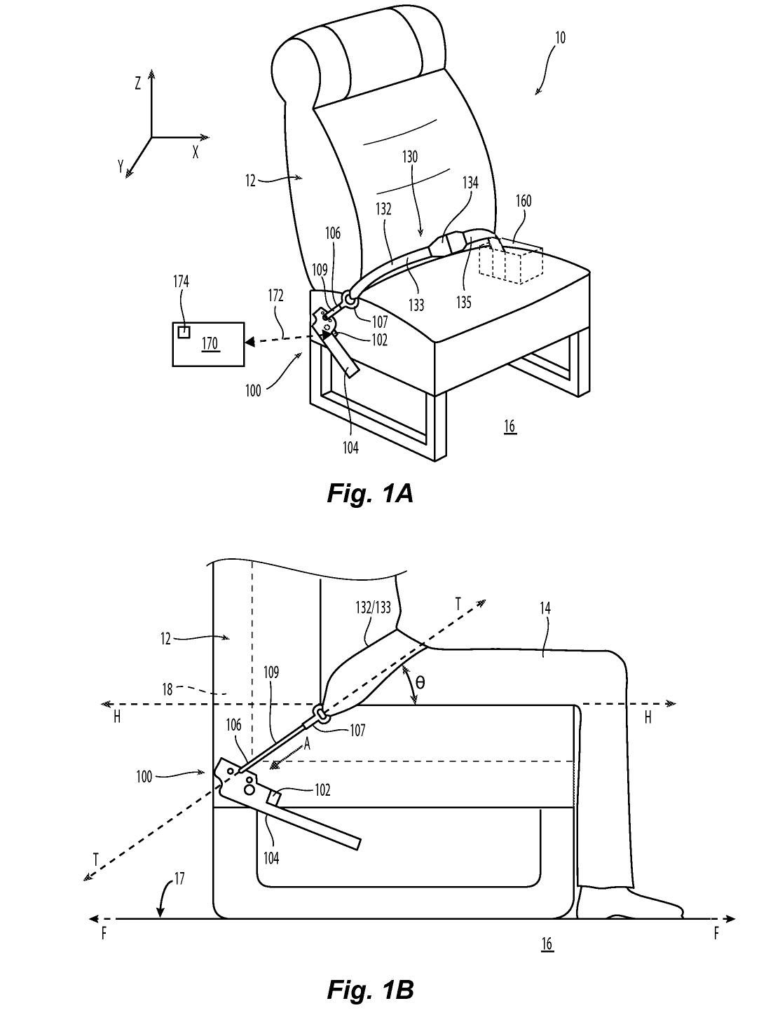

FIG. 1A is a partially-schematic front perspective view of an occupant restraint system 10 (“restraint system 10”) having a pretensioner 100 configured in accordance with an embodiment of the present technology. In the illustrated embodiment, the restraint system 10 secures an occupant 14 (see FIG. 1B) to a seat 12 in an aircraft 16. The restraint system 10 can include a restraint 130 and a sensor assembly 170 (shown schematically), both operably coupled to the pretensioner 100. As described in greater detail below, the sensor assembly 170 is configured to control activation of the pretensioner 100 to automatically adjust the tension of the restraint 130 in response to a predetermined dynamic event and/or force (e.g., rapid decelerations and/or accelerations, collisions, impacts, accident events, etc.).

In the illustrated embodiment, the restraint 130 includes a web or belt 132 configured to extend across the occupant's lap. As used herein, a “web” can include any type of flexible strap or belt, such as a seat belt made from woven material (e.g., woven nylon) as is known in the art for use with personal restraint systems. The web 132 can include flexible segments of a fixed length and/or adjustable length to accommodate different sized occupants. For example, in the illustrated embodiment, the web 132 includes a first web portion 133 and a second web portion 135. The distal ends of the first and second web portions 133, 135 can be releasably coupled together by a coupler 134 (e.g., a “lift-latch” buckle, a “press-release” buckle, etc.). A proximal end of the first web portion 133 can be coupled to the pretensioner 100, and a proximal end of the second web portion 135 can be coupled to an anchor point on the aircraft 16 (or a structure thereof) at a location that is opposite the side of the seat 12 where the pretensioner 100 is positioned. In the illustrated embodiment, for example, the proximal end of the second web portion 135 is coupled to a web retractor 160 (e.g., an inertial reel) fixed to the seat 12 and/or to an anchor point on the aircraft 16. The web retractor 160 is configured to automatically adjust the fit of the web 132 in response to movement of the occupant 14 and/or the aircraft 16 in a conventional manner. In other embodiments, the proximal end of the second web portion 135 can be fixed directly to the seat 12 or associated structure (e.g., the seat frame) and/or the web 132 can be manually adjustable, static, etc. Although only one pretensioner 100 is shown in FIG. 1A, in other embodiments the restraint system 10 can include two pretensioners 100. For example, in some embodiments, the restraint system 10 can include a first pretensioner coupled to the first web portion 133 and a second pretensioner coupled to the second web portion 135.

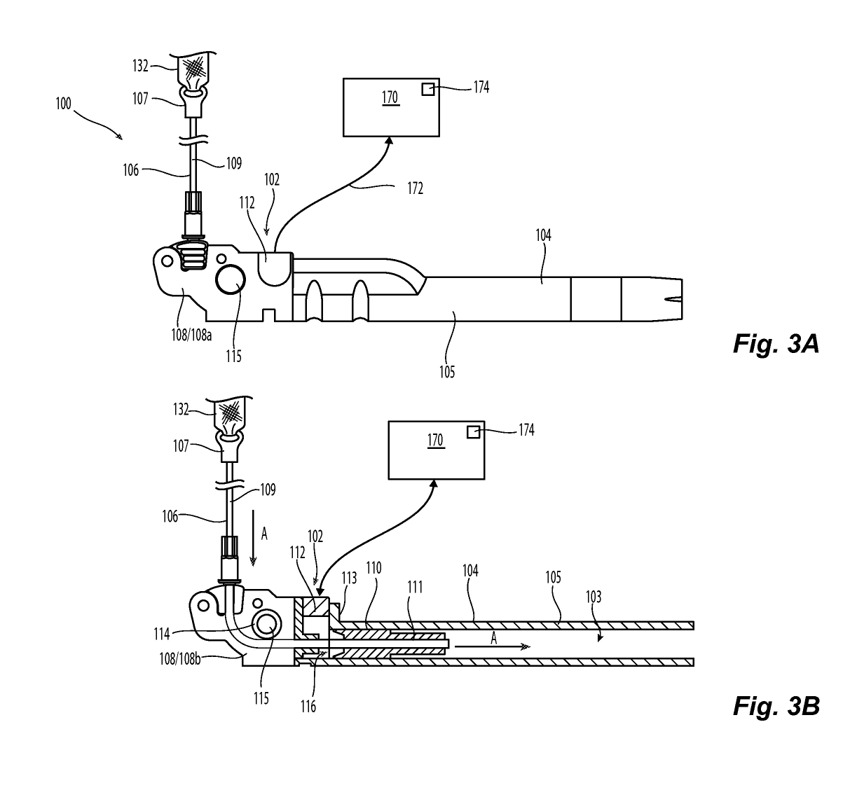

FIG. 1B is an enlarged side view of a portion of the occupant restraint system 10. Referring to FIGS. 1A and 1B together, the pretensioner 100 can include a housing 104 and a connecting member, such as a cable 106, extending through at least a portion of the housing 104. In the illustrated embodiment, the cable 106 has a first cable portion 111 extending within the housing 104 (described in greater detail below with reference to FIGS. 3A and 3B), and a second cable portion 109 extending from the housing 104 and coupled to the web 132 via, e.g., a connector 107. The pretensioner 100 can further include an activator 102 coupled to or integral with the housing 104. The activator 102 can be electrically connected or coupled to the sensor assembly 170 via an electrical link 172 (e.g., a wire, an electrical line, an electrical connector, wireless connection, etc.).

The sensor assembly 170 can include one or more sensors 174 (e.g., acceleration sensors, accelerometers, etc.) configured to sense acceleration and/or deceleration events above a preset magnitude (e.g., above 9 g's, where “g” refers to gravitational force or “g-force”) in one or more directions and send associated control signals to the pretensioner 100 via the link 172. For example, the sensor assembly 170 can include at least one acceleration sensor configured to sense vehicle accelerations in the vertical direction along a Z axis and one or more additional sensors configured to sense accelerations in the fore and aft directions along a X axis and/or laterally along a Y axis. In other embodiments, the sensor assembly 170 can include different sensor arrangements features and/or have a different number of acceleration and/or deceleration sensors. Other suitable sensor assemblies for use with the occupant restraint system 10, for example, can be found in, for example, U.S. Pat. No. 8,303,043, which is incorporated herein by reference in its entirety.

In the illustrated embodiment, the pretensioner 100 is configured to be attached to the seat 12 (e.g., a seat frame 18) and/or the aircraft 16. In some embodiments, the pretensioner 100 can take the place of a traditional seatbelt mount and can be mounted at or near a traditional seatbelt mounting location. For example, in some embodiments, the pretensioner 100 can be attached to a frame 18 (FIG. 1B) of the seat 12 with one or more bolts or other fastening devices configured to withstand the static and dynamic load requirements applicable to aircraft and/or aircraft seats (e.g., commercial aircraft and/or commercial aircraft seats). The seat 12 can be mounted to a floor 17 of the aircraft 16 (e.g., the floor of a passenger cabin). In the illustrated embodiment, the seat 12 defines a horizontal (or generally horizontal) seat axis H that extends parallel (or generally parallel) to the floor 17. Additionally, the second cable portion 109 is configured to be aligned with and extend along a tensioning axis T when the web 132 is properly installed (e.g., buckled) around the occupant 14. In the illustrated embodiment, the pretensioner housing 104 is coupled to a side portion of the seat frame 18 (FIG. 1B) such that the tensioning axis Tat the second cable portion 109 and the horizontal axis H of the seat 12 define a tensioning angle θ therebetween. In some embodiments, the tensioning angle θ can be between about 10 degrees and about 50 degrees. For example, the tensioning angle θ can be between about 20 degrees and about 45 degrees, or between about 30 degrees and about 40 degrees. In a particular embodiment, the tensioning angle θ can be 35 degrees or about 35 degrees when the web 132 is properly installed around the occupant 14. For example, the tensioning angle θ can be configured to be as close to 35 degrees as possible without being less than 35 degrees. In these embodiments, the occupant 14 can be represented by, for example, a 50th percentile anthropomorphic test device (ATD). During a dynamic event above a preset magnitude (e.g., rapid decelerations and/or accelerations, collisions, impacts, etc.), the sensor assembly 170 activates the pretensioner 100, causing the cable 106 to retract and pull the web 132 in a direction A at the tensioning angle θ. A tensioning angle θ of, e.g., about 35 degrees can reduce head path excursion by causing the web 132 to pull the occupant backwards in the seat. In the illustrated embodiment, the pretensioner housing 104 can be coupled to the side portion of the seat frame 18 at an angle of, for example, about 60 degrees below the horizontal axis H. In other embodiments, the pretensioner housing 104 can be coupled to the side portion of the seat frame 18 at other angles.

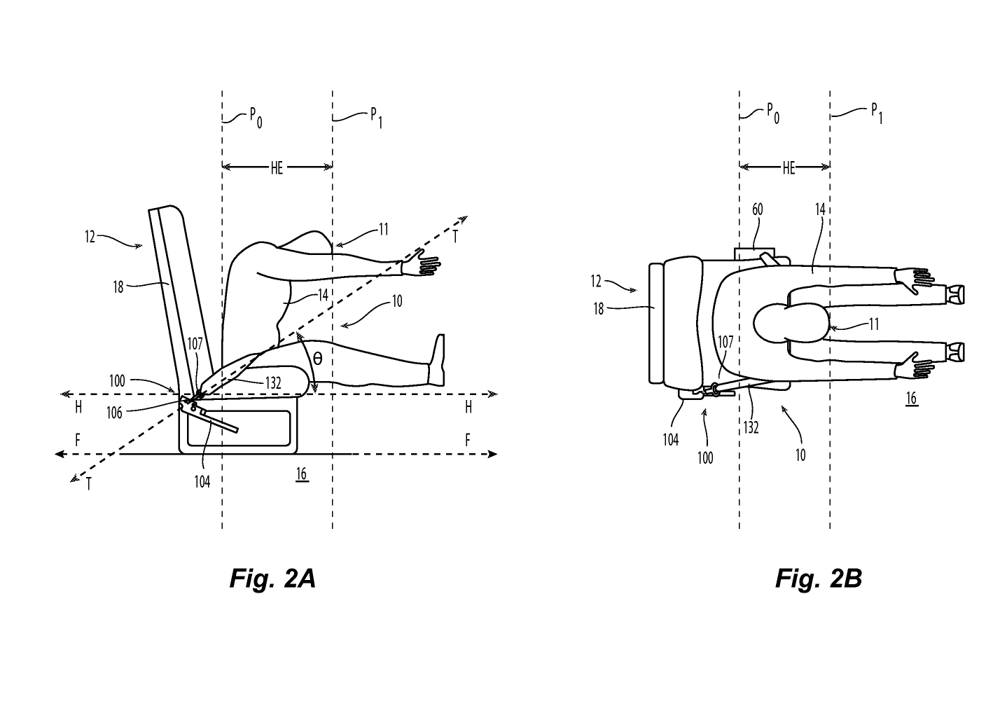

FIGS. 2A and 2B are side and top views, respectively, of the occupant restraint system 10 during or immediately after a dynamic event once the pretensioner 100 has been activated and tension is applied to the web 132. During a dynamic event, a forward-most portion 11 of the occupant's head moves from an initial position P₀ to a final, forward-most position P₀. The distance measured between P₀ to P₁ is known as the head path excursion HE of the occupant 14. Reducing head path excursion HE can be especially important in commercial aircraft, as the distance between rows of seats or the distance from the seat to a forward partition may be small. The occupant restraint system 10 of the present technology can reduce head path excursion HE during a dynamic event (e.g., rapid decelerations and/or accelerations, collisions, impacts, etc.) by applying tension to the web 132 (via the pretensioner 100) at a tensioning angle θ of, e.g., less than 45 degrees, such as 35 degrees or about 35 degrees.

Although the pretensioner 100 of the illustrated embodiments is shown fixed to a side portion of the seat 12, it will be appreciated that in some embodiments, the pretensioner 100 can be positioned at different locations in the aircraft 16, such as at a rear portion of the seat 12, so long as the tensioning angle θ is maintained as described above.

### II. Selected Embodiments of Pretensioners

FIGS. 3A and 3B are partially-schematic side and cross-sectional side views, respectively, of the pretensioner 100 before installation on the aircraft seat 12. Referring to FIGS. 3A-3B together, the housing 104 of the pretensioner 100 can include a bracket or mount 108 and a generally linear tube 105 extending from mount 108. The mount 108 can include opposing first and second sides 108a, 108b (only the interior portion of the first side 108b shown in FIG. 3B) and a pulley 114 (FIG. 3B) rotatably supported between the first and second sides 108a, 108b by a pin or shaft 115. In the illustrated embodiment, the tube 105 includes a cylindrical interior portion 103, and a piston 110 (FIG. 3B) is slidably positioned within the interior 103.

The cable 106 is operably coupled between the web 132 and the piston 110, with the second cable portion 109 being fixedly coupled to the web 132 via the connector 107 and the first cable portion 111 being fixedly coupled to the piston 110 within the interior portion 103 of the housing 104. In this embodiment, a mid-portion of the cable 106 can contact and curve around the pulley 114.

The activator 102 can be a gas generator 112 (shown schematically) fitted in a socket 113 formed on the housing 104 in fluid communication with a portion 116 of the tube interior 103. The gas generator 112 can be a pyrotechnic element (e.g., an initiator, etc.) as is known in the art and can be activated by an electrical signal generated by the sensor assembly 170 (FIG. 3A) and communicated to the generator 112 by the link 172 in response to, e.g., a dynamic event above a preset magnitude.

In operation, when the sensor(s) 174 of the sensor assembly 170 sense an aircraft acceleration and/or deceleration above a preset magnitude, the sensor assembly 170 sends a corresponding electrical signal to the activator 102 via the link 172. The activator 102 responds to the signal by activating the gas generator 112. The generator 112 then generates combustion gases which increase the pressure within a portion 116 of the tube 105. As the pressure inside the tube 105 increases on one side of the piston 110, it drives the piston 110 to the right (as indicated by arrow A) thereby pulling the cable 106 into the housing 104. As the second cable portion 109 is retracted into the tube 105, it pulls the web 132 downwardly and aft at the tensioning angle θ, as described above with reference to FIGS. 1A-2B. In one embodiment, the pretensioner 100 can be configured to retract up to 4 inches of the cable 106. In other embodiments, the pretensioner 100 can be configured to retract other lengths of the cable 106. In some embodiments, the sensor assembly 170 activates the pretensioner in less than 50 milliseconds (ms) after the start of the acceleration and/or deceleration event sensed by the sensor assembly 170. For example, the pretensioner activation time can be between about 37 ms and about 47 ms, or about 42 ms. In some embodiments, the pretensioner retraction time, or the time it takes for the pretensioner 100 to retract the preset length of the cable 106 after activation of the pretensioner 100 can be less than 15 ms. For example, the pretensioner activation time can be between about 8 ms and about 12 ms, or about 10 ms. The pretentionser timing described above can reduce occupant forward excursion by tensioning the web 132 before the occupant's body significantly loads the web 132 due to his forward excursion. In these embodiments, significant belt loading by the occupant's body starts after the web 132 has already been retracted, for example, about 4 inches.

In some embodiments, the pretensioner 100 can be load-limiting. In other words, in some embodiments, the pretensioner 100 can be configured to stop retracting the cable 106 (and thus cease pulling on the web 132) when a tension load on the web 132 (exerted by the occupant) reaches a preset force magnitude. For example, in some embodiments, the preset force can be between about 430 lbs. and about 530 lbs., or between about 460 lbs. and about 500 lbs. In a particular embodiment, the preset force magnitude can be about 480 lbs. Moreover, in some embodiments the pretensioner 100 can be configured to sustain an applied load of at least 3,000 lbs. both before and after retraction of the cable 106. In other embodiments, the pretensioner 100 can be configured to hold other loads.

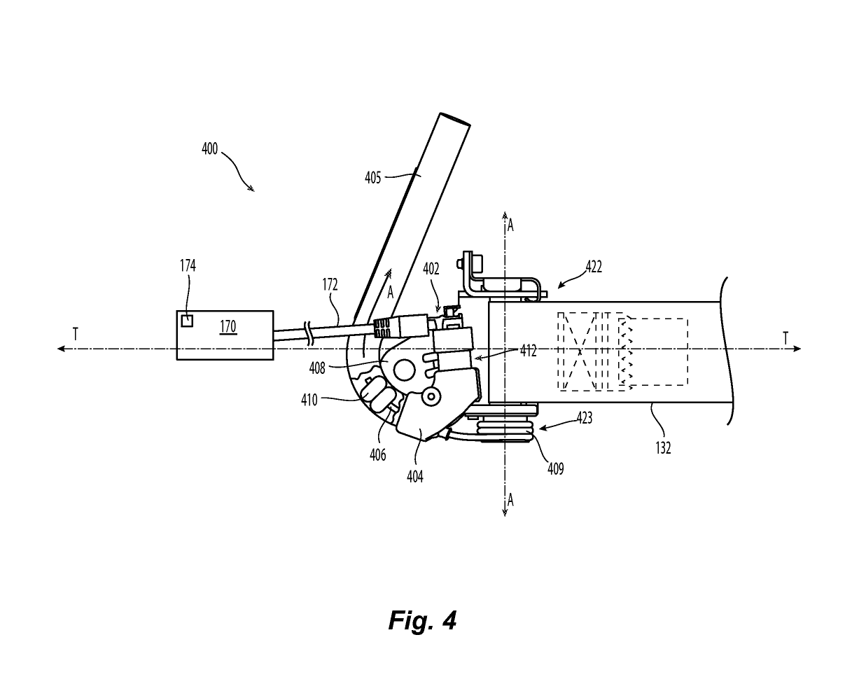

In other embodiments, the occupant restraint system 10 configured in accordance with the present technology can include other types of pretensioners. Such pretensioners can include, for example, other suitable electrical, mechanical, pneumatic, hydraulic, and/or electromechanical pretensioning devices. FIG. 4, for example, shows a front view of a rotary pretensioner 400 that can be used with the occupant restraint system 10 of the present technology. A portion of the exterior of the pretensioner 400 is removed for purposes of illustration. In the illustrated embodiment, the rotary pretensioner 400 includes a mount 408, a curved tube 405, a piston 410 slidably positioned within the tube 405, and an activator 402 in fluid communication with the tube 405. The activator 402 can include and/or can be operably connected to a gas generator 412 electrically connected to the sensor assembly 170 via the link 172. The pretensioner 400 can further include a rotatable first spool 422 coaxially coupled to a second spool 423. A proximal end portion of the web 132 can be wound around the first spool 422. A cable 406 has a first cable portion 411 coupled to the piston 410 and a second cable portion 409 is wound around the second spool 423.

In operation, in response to a dynamic event above a preset magnitude, the sensor assembly 170 sends an electrical signal to the activator 402 via the link 172. The activator 402 then activates the gas generator. Upon activation of the generator, combustion gases are generated which increase the pressure within the tube 405 on the upstream side of the piston 410. As the pressure inside the tube 405 increases on one side of the piston 410, it drives the piston 410 through the tube 405 (as indicated by arrow A) thereby retracting the cable 406. As the cable 406 retracts, the cable 406 rotates the second spool 423, thereby rotating the first spool 422 and retracting the web 132 in the direction A as described above with references to FIGS. 1A and 1B. In one embodiment, the pretensioner 400 can be configured to retract up to 3.5 inches of the web 132. In other embodiments, the pretensioner 400 can be configured to retract other lengths of the cable 106.

### III. Additional Embodiments of Occupant Restraint Systems

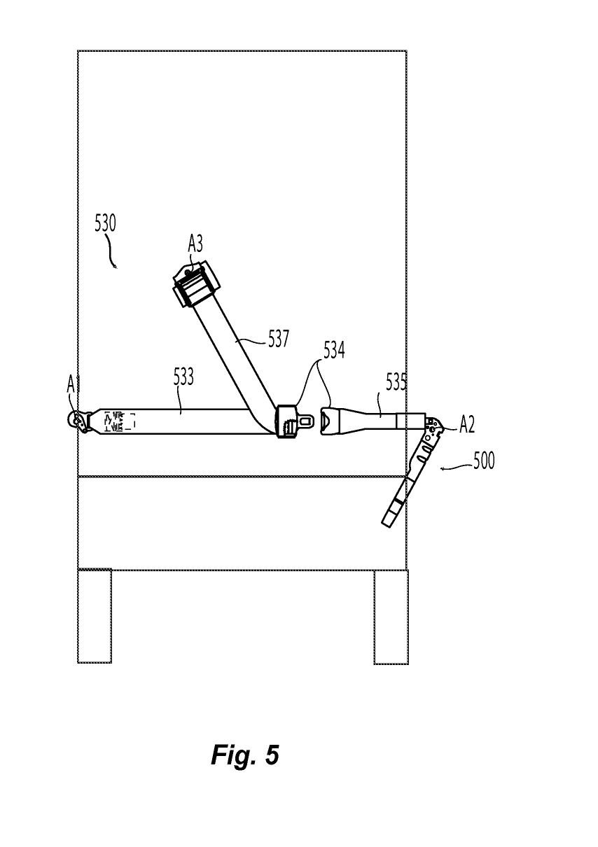

In other embodiments, the occupant restraint system 10 can include different features and/or have different configurations. For example, although the occupant restraint system 10 illustrated in FIGS. 1A-2B includes a two-point web 132, one skilled in the art will appreciate that the pretensioning systems described herein can be used with other occupant restraint systems, such as three- and four-point systems. FIG. 5, for example, is a front view of a three-point restraint system 530 configured for use with the occupant restraint system 10 of the present technology. The three-point restraint 530 can include a first web portion 533, a second web portion 535, and a third web portion 537. The first and second web portions 533, 535 are configured to be positioned across an occupant's lap or waist region, and the third web portion 537 is configured to extend upwardly from the first web portion 533 (and/or the second web portion 535) across the occupant's chest and over the occupant's shoulder. In the illustrated embodiment, a buckle 534 can be used to releasably attach the first and second web portions 533, 537 to the third web portion 535.

The restraint 530 can be configured to be coupled to an aircraft seat (shown schematically) and/or an aircraft cabin structure (not shown) at a first attachment point A1 positioned at a proximal end of the first web portion 533, a second attachment point A2 positioned at a proximal end of the second web portion 535, and a third attachment point A3 positioned at a proximal end of the third web portion 537.

In the illustrated embodiment, the restraint 530 includes a pretensioner 500 coupled to the proximal end portion of the second web portion 535. The pretensioner 500 can be any of the pretensioners described herein. In other embodiments, more than one pretensioner 500 can be coupled to the restraint 530 and/or the pretensioner 500 can be coupled to the first and/or third portions 533, 537.

### IV. Conclusion

From the foregoing, it will be appreciated that specific embodiments have been described herein for purposes of illustration, but that various modifications may be made without deviating from the spirit and scope of the various embodiments of the disclosure. For example, the occupant restraint systems described above with reference to FIGS. 1A-5 may have different configurations and/or include different features. Moreover, specific elements of any of the foregoing embodiments can be combined or substituted for elements in other embodiments. For example, the occupant restraint systems described in the context of specific vehicles (e.g., automobile or aircraft systems) can be implemented in a number of other types of vehicles (e.g., non-automobile or non-aircraft systems). Certain aspects of the disclosure are accordingly not limited to automobile or aircraft systems. Furthermore, while advantages associated with certain embodiments of the disclosure have been described in the context of these embodiments, other embodiments may also exhibit such advantages, and not all embodiments need necessarily exhibit such advantages to fall within the scope of the invention. Accordingly, the disclosure is not limited, except as by the appended claims.

I/we claim:

1. An occupant restraint system for use in an aircraft, the occupant restraint system comprising:
a flexible and elongate web configured to extend across at least a portion of an occupant seated in a seat;
an electronically-actuated pretensioner operably coupled to an end portion of the web; and
a sensor assembly operably connected to the pretensioner, wherein the sensor assembly is configured to send an electrical signal to the pretensioner in response to an aircraft acceleration or deceleration above a preset magnitude, and wherein, in response to receiving the electrical signal from the sensor assembly, the pretensioner is configured to automatically increase tension in the web.

2. The occupant restraint system of claim 1 wherein:
the pretensioner includes a housing and a cable;
the cable has a first cable portion positioned within the housing and a second cable portion extending from the housing and operably coupled to the end portion of the web; and
in response to receiving the electrical signal from the sensor assembly, the pretensioner is configured to retract the cable into the housing and increase tension in the web.

3. The occupant restraint system of claim 2 wherein the pretensioner further includes a piston slidably disposed within the housing and operably coupled to the first cable portion, and wherein in response to receiving the electrical signal from the sensor assembly, the piston is driven into the housing to retract the cable and increase tension in the web.

4. The occupant restraint system of claim 2 wherein the pretensioner further includes a piston slidably disposed within the housing and a rotatable spool, wherein the first cable portion is operably coupled to the piston and the second cable portion is operably coupled to the spool, and wherein in response to receiving the electrical signal from the sensor assembly, the piston is driven into the housing to retract the cable, whereby the cable rotates the spool to increase tension in the web.

5. The occupant restraint system of claim 1 wherein the pretensioner includes a flexible connecting member extending from a pretensioner body, wherein the connecting member has a distal end portion coupled to the end portion of the web, wherein the connecting member extends along a tensioning axis between the pretensioner body and the web when the web is secured around the occupant, and wherein the tensioning axis extends at an angle that is greater than 10 degrees and less than 45 degrees relative to a horizontal axis of the seat.

6. The occupant restraint system of claim 5 wherein the seat is mounted to a floor surface of the aircraft, and wherein the horizontal axis of the seat extends parallel to the floor surface.

7. The occupant restraint system of claim 6 wherein:
the tensioning axis extends at an angle that is between about 15 degrees and about 40 degrees relative to the horizontal axis of the seat.

8. The occupant restraint system of claim 6 wherein:
the tensioning axis extends at an angle of about 35 degrees relative to the horizontal axis of the seat.

9. The occupant restraint system of claim 1 wherein:
the web includes:
a first web portion having a first distal end and a first proximal end operably coupled to the pretensioner; and
a second web portion have a second distal end and a second proximal end;
and wherein the first distal end is releasably coupleable to the second distal end via a buckle.

10. The occupant restraint system of claim 1 wherein the pretensioner is positioned toward a first side of the seat, and wherein the occupant restraint system further comprises a web retractor positioned toward an opposite, second side of the seat, wherein the end portion of the web is a first end portion, and wherein the web further comprises a second end portion, opposite the first end portion and operably coupled to the web retractor.

11. The occupant restraint system of claim 1 wherein the pretensioner is a linear pretensioner.

12. The occupant restraint system of claim 1 wherein the pretensioner is a rotary pretensioner.

13. The occupant restraint system of claim 1 wherein the occupant restraint system is a two-point occupant restraint system.

14. The occupant restraint system of claim 1 wherein the web is configured to extend across a lap of the occupant.

15. The occupant restraint system of claim 1 wherein the web is configured to extend across a lap of the occupant, and wherein the web is the sole restraint web included in the occupant restraint system.

16. The occupant restraint system of claim 1 wherein the occupant restraint system is a three-point occupant restraint system.

17. A seating system for use in an aircraft, the seating system comprising:
an aircraft seat, wherein the seat is mounted to a floor that defines a horizontal axis of the seat;
a flexible and elongate web configured to extend across a lap of an occupant seated on the seat, wherein the web includes—
a first web portion having a first distal end portion and a first proximal end portion;
a second web portion have a second distal end portion and a second proximal end portion; and
wherein the first distal end portion is releasably coupleable to the second distal portion via a buckle; and
an electronically-actuated pretensioner fixedly mounted proximate the seat, the pretensioner including—
a housing; and
a cable, wherein the cable has a first cable portion extending within the housing and a second cable portion extending between the housing and the first web portion, wherein the second cable portion is coupled to the first proximal end portion of the first web portion, wherein the second cable portion extends along a tensioning axis, and wherein the tensioning axis extends at an angle that is less than 45 degrees relative to the horizontal axis of the seat when the web extends across the lap of the seat occupant.

18. The seating system of claim 17 wherein the angle is between about 15 degrees and about 40 degrees.

19. The seating system of claim 17 wherein the angle is between about 30 degrees and about 40 degrees.

20. The seating system of claim 17 wherein the angle is about 35 degrees.

21. The seating system of claim 17, further comprising a sensor assembly operably connected to the pretensioner, wherein the sensor assembly is configured to send an electrical signal to the pretensioner in response to an aircraft acceleration or deceleration above a preset magnitude, and wherein, in response to receiving the electrical signal from the sensor assembly, the pretensioner is configured to automatically increase tension in the web.

22. The seating system of claim 17 wherein the pretensioner is a linear pretensioner.

23. The seating system of claim 17, further comprising a web retractor coupled to the second proximal end portion of the second web portion.
